(19) United States
(12) Patent Application Publication
(10) Pub. No.: US 2012/0016696 A1
(43) Pub. Date: Jan. 19, 2012

(54) Home-based Money Transaction Method

(76) Inventor: Huckjin Lee, Valencia, CA (US)

(21) Appl. No.: 12/836,316

(22) Filed: Jul. 14, 2010

(51) Int. Cl. G06Q 30/00; G06Q 10/00; G06K 7/00; G01S 19/42; G06F 3/048

(52) U.S. Cl. 705/5; 235/380; 342/357.25; 715/810; 705/26.41

(57) ABSTRACT

A home-based money transaction method includes steps of asking money transaction by a consumer by inputting a money transaction request to a transaction device, which is located in the customer's address, validating the money transaction request by a sale server, approving the money transaction request by a money transaction entity and transferring money, the amount of which is specified in the money transaction request to a merchant that is specified in the money transaction request. The transaction device provides data for geographic location in which the transaction device is located. In the validating step, the sale server authenticates the identity of the transaction device by comparing the geographic location data of the transaction device with the address of the consumer. The data may be provided with a GPS, IP address, MAC address. A device ID associated with consumer data further provides authentication means.

### BACKGROUND OF THE INVENTION

1. Field of the Invention

The invention is related to an electronic money transaction method. More particularly, the present invention is related to an electronic money transaction method that is based on a hardware payment device that is authenticated with geographic location data.

2. Description of the Prior Art

The most secure way for any transaction is with cash. However, with online shopping, credit card has becomes the most popular form of payment. Fraud is a big problem on the internet and a careless consumer can be targeted. Most of the time, you are making a transaction across the internet without knowing who you are dealing with. Theft of credit card and personal information is often all somebody needs to be able to spend all your money on the internet. Being able to purchase and buy items with very little proof of your identity is another big downside to e-commerce. Where as in a shop front using a credit card at least requires a signature as well as for the offending criminal to show himself.

With the development of the new technology like internet, consumers are fundamentally changing the way they shop and buy goods and services. Therefore, consumers are seeking reliability and security which can be seen in the purchase of goods and services over the internet via secure servers with e-shopping carts and with electronic pay services, like credit card payment authorizations.

However, online credit card payment by prior art requires cumbersome registration process for each merchant. Also user name and password management for each of the online processes is a big burden that requires user's extensive care. The most serious problem in online transaction is that payment is possible anywhere in the world only with card information and without the credit card itself. That is, the convenience of online transaction with only card information is prone to serious security problem. A method that incorporates the simplicity of a store front transaction and the convenience of online transaction has long been in need.

### SUMMARY OF THE INVENTION

An objective of the invention is to provide an electronic money transaction method that standardizes authentication of a credit card transaction regardless of merchants to which payments by the credit card is to be done.

Another objective of the invention is to provide a home based money transaction center that integrates all online money transactions.

In order to achieve the objectives, the present invention provides a home-based money transaction method that includes steps of asking money transaction by a consumer by inputting a money transaction request to a transaction device, which is located in the consumer's address and validating the money transaction request by a sale server. The transaction device is connected to the sale server via the Internet. The transaction device provides data for geographic location in which the transaction device is located. In the validating step, the sale server authenticates the identity of the transaction device by comparing the geographic location data of the transaction device with the address of the consumer.

The transaction device comprises a credit card reading module, and the inputting of the money transaction request is performed by reading a credit card and reading amount of money for which money transaction is requested.

The transaction device comprises a GPS module, wherein the geographic location data comprises a location data of the transaction device provided by the GPS module. Alternately, the transaction device comprises a TCP/IP node, wherein the geographic location data comprises the MAC address of the TCP/IP node. Alternately, the geographic location data comprises an IP address of a TCP/IP node of the internet, which is nearest to the transaction device.

Further, the transaction device comprises a unique device ID, and the device ID is linked to identity data of the consumer.

After the step of validating, the method further comprises steps of authenticating the consumer in which the consumer inputs consumer authentication data into the transaction device; approving the money transaction request by a money transaction entity; and transferring money, the amount of which is specified in the money transaction request to a merchant that is specified in the money transaction request. The sale server, the money transaction entity and the merchant are connected with one another via the Internet. In the step of authenticating the consumer, the consumer authentication data comprises the zip code of the consumer's billing address and the sale server compares the zip code input with the zip code of the transaction device that is preregistered at the sale server. The consumer authentication data further comprises signature of the consumer. The consumer signs at a touch screen of the transaction device.

In the first embodiment, before the step of asking money transaction, the method further comprises steps of online shopping in which the consumer chooses goods or service occurs in a online shopping mall website and sending data for the chosen goods or service by the online shopping mall website to the sale server. In this embodiment, the merchant is an online shopping mall that operates the online shopping mall website. In the asking money transaction step, the sale server provides a web interface for inputting money transaction that shows the amount for the chosen goods or services. The online shopping mall shares data with the sale server.

In the second embodiment, before the step of asking money transaction, the method further comprises steps of connecting to a TV home shopping mall website with the transaction device, inputting a product ID to the transaction device, and obtaining price data and product information for the product ID. The transaction device provides an icon for the TV home shopping mall website. The product ID is known by the TV home shopping channel broadcasting. The sale server asks the price for the product ID to a TV home shopping mall that operates the TV home shopping mall website and obtains the price data from the TV shopping mall. In this embodiment, the merchant is the TV shopping mall.

In the third embodiment, before the step of asking money transaction, the method further comprises steps of sending price data to the sale server by the merchant and displaying the price data for a product provided by the merchant at the transaction device. In the asking money transaction step, the price data is used as the amount of money for which money transaction is requested, and the sale server provides the price data to the transaction device.

In the fourth embodiment, before the step of asking money transaction, the method further comprises steps of choosing an icon, which points to the homepage of a service provider for which a bill is to be paid, on the transaction device; and choosing payment service at the homepage. An account number for the service provider can be stored in the transaction device for consumers' convenience. The choosing payment step starts the asking money transaction step. Data handled by the asking money transaction step comprises the account number. In this embodiment, the service provider is the merchant.

In the fifth embodiment, before the step of asking money transaction, the method further comprises steps of sending a bill to the sale server by a service provider, sending a bill payment request by the sale server to the transaction device of a consumer to which an account number of the service provider corresponds, and opening the bill payment request by the consumer to review contents of the bill payment request. The bill payment request is stored in an invoice folder of the transaction device. In this embodiment, the service provider is the merchant. The method may further comprise, after sending the bill payment request step, a step of providing an alarm by the transaction device to the consumer.

In the sixth embodiment, before the step of asking money transaction, the method further comprises steps of finding a desired service by a service provider at the transaction device; and reserving the desired service with the service provider's website at the transaction device. After approving the money transaction request step, the method further comprises steps of providing a reservation confirmation notice by the transaction device; printing reservation confirmation information and number or barcode on a receipt by the transaction device; and accepting the receipt by the service provider before providing the service to the consumer. The service provider shares data with the transaction device. In this embodiment, the service provider is the merchant.

In another aspect of the present invention, a home-based money transaction method comprising the steps of asking money transaction by a consumer by inputting a money transaction request to a first transaction device, wherein the first transaction device is located in the consumer's address; relaying the money transaction request to a second transaction device by a sale server, wherein the second transaction device is located in a merchant's address; approving the money transaction request by a money transaction entity; and transferring money, the amount of which is specified in the money transaction request to the merchant. The first transaction device, the sale server, the second transaction device and the money transaction entity are connected with one another via the Internet. The first transaction device provides data for geographic location in which the first transaction device is located and the second transaction device provides data for geographic location in which the second transaction device is located. In the relaying step, the sale server authenticates the identity of the first transaction device by comparing the geographic location data of the transaction device with the address of the consumer, and authenticates the identity of the second transaction device by comparing the geographic location data of the second transaction device with the address of the merchant.

In the seventh embodiment, in the step of asking transaction, the first transaction device displays an order and payment window that is stored in the first transaction device and the consumer places an order and inputs payment data. In the step of relaying, the money transaction request comprises the order data and the payment data. In the step of approving, the money transaction entity communicates with the second transaction device. In the step of transferring money, the second transaction device prints a receipt for the money transaction. The second transaction device displays the order data and the payment data in an order and payment window that is stored in the second transaction device.

The eighth embodiment, before the step of asking money transaction, further comprises a step of telephone communication in which the consumer calls the merchant. The first transaction device and the second transaction device provide VoIP function and the telephone communication is performed with the first transaction device and the second transaction device. The merchant inputs order data to the second transaction device and the sale server transfers the order data to the first transaction device and the first transaction device displays the order data. In the step of transferring money, the first transaction device prints a first receipt for the money transaction and the second transaction device prints a second receipt for the money transaction.

The advantageous effects of the present invention are: (1) secure and reliable solutions for consumers and businesses are provided; (2) the method protects merchants as well as consumers; (3) consumers don't have to release their person information at all; (4) every sales will accompany actual receipt which allows them to have a hard copy of their transaction; and (5) credit card payment with the transaction device requires possession of the credit card itself thereby strengthening identification of the transaction. Only a person who actually possesses the credit card can pay with the credit card.

### BRIEF DESCRIPTION OF THE DRAWINGS

The accompanying drawings illustrate the best embodiments of the present invention. In the drawings:

FIG. 1 is a perspective view showing a home-based transaction device according to the present invention;

FIG. 2 is a block diagram showing the general role of a sale server;

FIG. 3 is a block diagram showing application examples of the present invention;

FIG. 4 is a schematic diagram showing elements of the transaction device;

FIG. 5 is a flow diagram showing basic functions of the present invention;

FIG. 6 is a flow diagram showing the first embodiment of the present invention;

FIG. 7 is a flow diagram showing the second embodiment of the present invention;

FIG. 8 is a flow diagram showing the third embodiment of the present invention;

FIG. 9 is a flow diagram showing the fourth embodiment of the present invention;

FIG. 10 is a flow diagram showing the fifth embodiment of the present invention;

FIG. 11 is flow diagram showing the sixth embodiment of the present invention;

FIG. 12 is a block diagram showing an example in which a merchant also uses the transaction device;

FIG. 13 is a flow diagram showing the seventh embodiment of the present invention;

FIG. 14 is a flow diagram showing the eighth embodiment of the present invention;

FIG. 15 is a schematic diagram showing hardware layout of the transaction device;

FIG. 16 is a top plan view of the transaction device;

FIG. 17 is a side elevation view of the transaction device;

FIG. 18 is a front elevation view of the transaction device; and

FIG. 19 is a bottom plan view of the transaction device.

### DESCRIPTION OF PREFERRED EMBODIMENTS

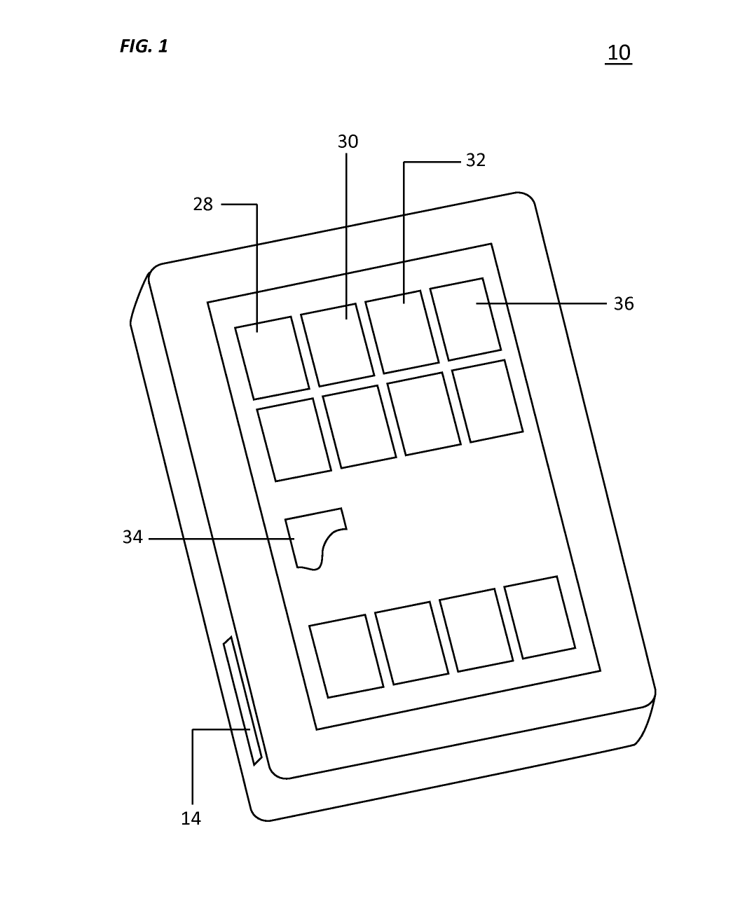

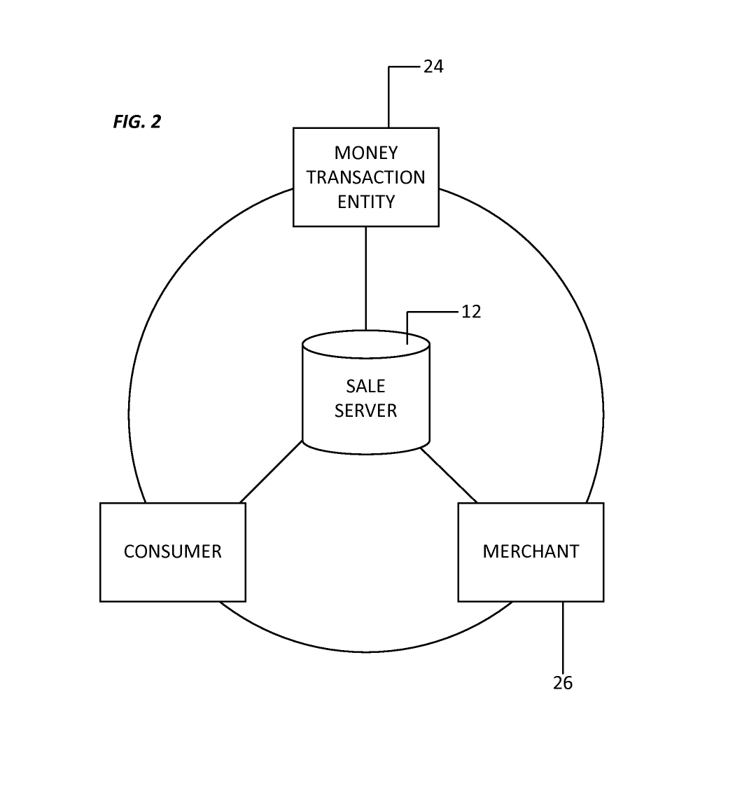

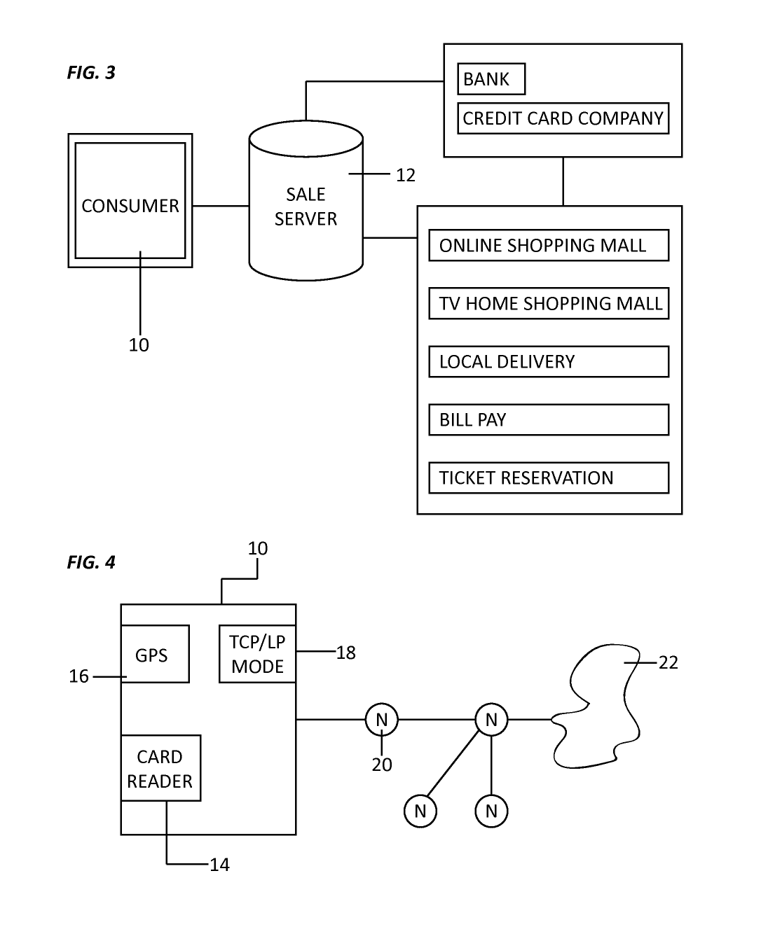

The present invention provides a home-based money transaction method. FIG. 5 shows basic steps for the method. The method includes step S01 of asking money transaction by a consumer by inputting a money transaction request to a transaction device 10 (refer to FIGS. 1 and 3), which is located in the consumer's address, and step S02 of validating the money transaction request by a sale server 12 (refer to FIGS. 2 and 3). The transaction device 10 is connected to the sale server 12 via the Internet. The transaction device 10 provides data for geographic location in which the transaction device 10 is located. In the validating step, the sale server 12 authenticates the identity of the transaction device by comparing the geographic location data of the transaction device 10 with the address of the consumer.

As shown in FIG. 1, the transaction device 10 comprises a credit card reading module 14, and the inputting of the money transaction request is performed by reading a credit card and reading amount of money for which money transaction is requested. A debit card may also be used because both cards have the same function regarding the method of the present invention.

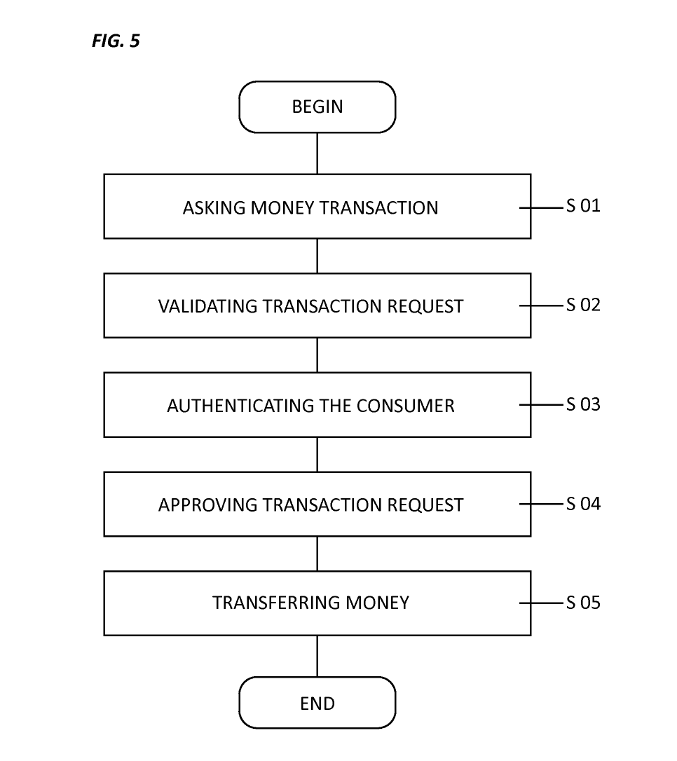

As shown in FIG. 4, the transaction device 10 comprises a GPS module 16, and the geographic location data comprises a location data of the transaction device provided by the GPS module. Further, the transaction device comprises a TCP/IP node 18, and the geographic location data comprises the MAC address of the TCP/IP node 18. Still further, the geographic location data comprises an IP address of a TCP/IP node 20 of the Internet 22, which is nearest to the transaction device 10. Still further, the transaction device comprises a unique device ID, and the device ID is linked to identity data of the consumer. The sale server 12 maintains a database for the relation of each consumer and the consumer's transaction device's ID. Any or any combination of the above authentication factors may be used to check whether a money transaction request is from the transaction device assigned to the consumer.

Referring back to FIG. 5, after the step S02 of validating, the method further comprises step S03 of authenticating the consumer in which the consumer inputs consumer authentication data into the transaction device; step S04 of approving the money transaction request by a money transaction entity 24; and step S05 of transferring money, the amount of which is specified in the money transaction request to a merchant 26 that is specified in the money transaction request. As shown in FIG. 2, the sale server 12, the money transaction entity 24 and the merchant 26 are connected with one another via the Internet. In this way, the money transaction becomes final and complete and a receipt can be printed by the transaction device 10 similar to the credit card transaction occurring at a retail store. In the step S03 of authenticating the consumer, the consumer authentication data comprises the zip code of the consumer's billing address and the sale server compares the zip code input with the zip code of the transaction device that is preregistered at the sale server. If the zip codes are different the sale server may issue an error message to the transaction device and may turn down the money transaction request after repeated failure of correct input. The consumer authentication data further comprises signature of the consumer. The consumer signs at a touch screen of the transaction device. The zip code input and comparison further strengthens the security of money transaction with the transaction device of the present invention. The signature of the consumer also strengthens the security and can be used as authentication evidence at a possible dispute.

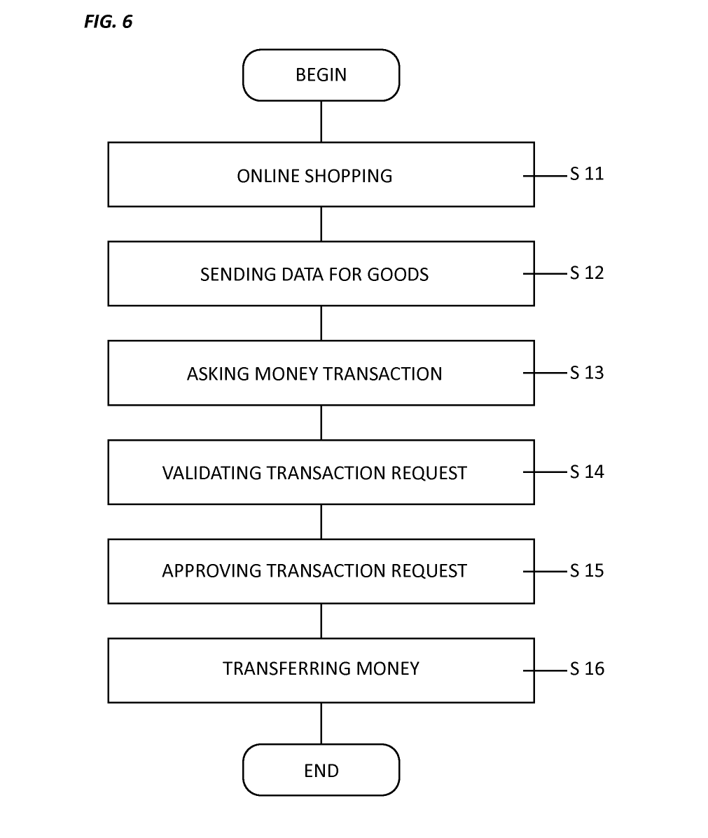

FIG. 6 shows the first embodiment of the present invention. In this embodiment, before the step S13 of asking money transaction, the method further comprises step S11 of online shopping in which the consumer chooses goods or service occurs in a online shopping mall website and step S12 sending data for the chosen goods or service by the online shopping mall website to the sale server 12. In this embodiment, the merchant is an online shopping mall that operates the online shopping mall website. In the asking money transaction step S13, the sale server 12 provides a web interface for inputting money transaction that shows the amount for the chosen goods or services. The online shopping mall shares data with the sale server 12. Examples of online shopping malls include Ebay and Amazon. The web interface provided by the sale server is added as an optional payment method in the payment window of the online shopping mall.

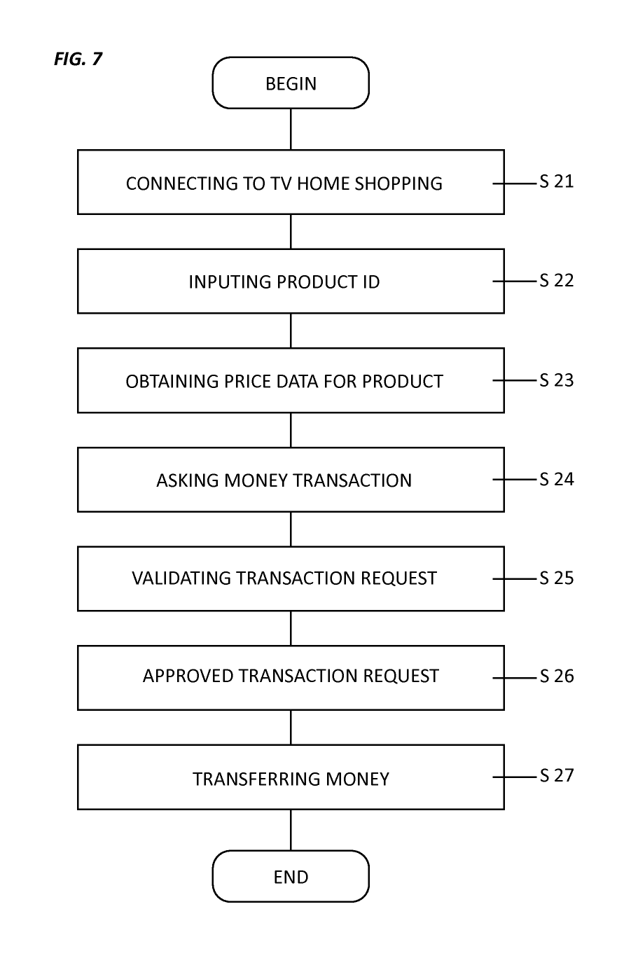

FIG. 7 shows the second embodiment of the present invention. In this embodiment, before the step of asking money transaction S24, the method further comprises step S21 of connecting to a TV home shopping mall website with the transaction device, step S22 of inputting a product ID to the transaction device 10, and step S23 of obtaining price data and product information for the product ID. The transaction device 10 provides an icon 28 (refer to FIG. 1) for the TV home shopping mall website. The product ID is known by the TV home shopping channel broadcasting. The sale server 12 asks the price for the product ID to a TV home shopping mall that operates the TV home shopping mall website and obtains the price data from the TV shopping mall. In this embodiment, the merchant 26 is the TV shopping mall. An example of TV home shopping channel is NBS Shop. Networking with the TV home shopping mall is required for product ID inquiry, etc. When a consumer who watches a TV home shopping channel wants to purchase a product from the channel, she clicks a target home shopping icon 30 (refer to FIG. 1) on the transaction device 10, which displays a product inquiry page. Then she inputs the product ID she read from the channel to the transaction device. The transaction device sends the product ID to the sale server 12, which in turn connects to an internet server of the TV shopping mall and transfers product information and price to the transaction device.

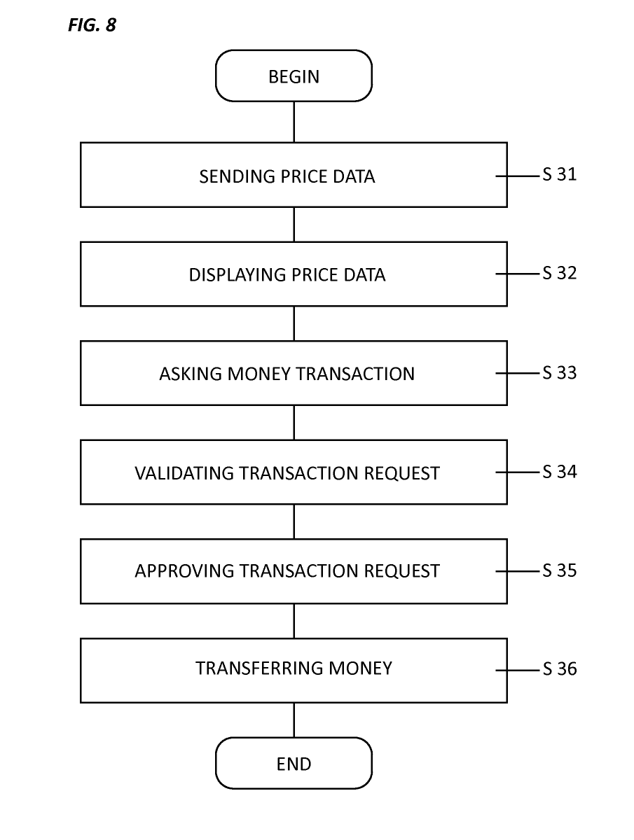

FIG. 8 shows the third embodiment of the present invention. In this embodiment, before the step of asking money transaction S33, the method further comprises step S31 of sending price data to the sale server 12 by the merchant 26 and step S32 of displaying the price data for a product provided by the merchant 26 at the transaction device 10. In the asking money transaction step S33, the price data is used as the amount of money for which money transaction is requested, and the sale server 12 provides the price data to the transaction device 10. This embodiment is useful for local delivery business such as Pizza Hut, Domingo's Pizza, VONs, Ralphs, etc. The sale server 12 needs to share or provide an online order and payment system with such businesses. A consumer finds a local delivery store from a yellow page, and calls the store to order. During the call, the store sends a payment request, and the payment request is displayed on the screen of the consumer's transaction device 10.

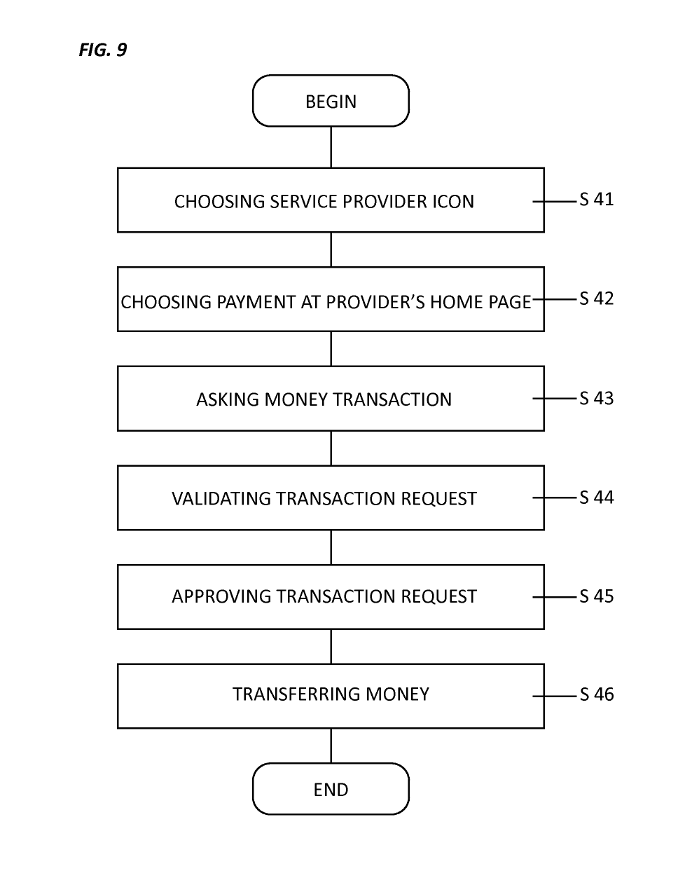

FIG. 9 shows the fourth embodiment of the present invention. In this embodiment, before the step of asking money transaction S43, the method further comprises step S41 of choosing an icon 32 (refer to FIG. 1), which points to the homepage of a service provider for which a bill is to be paid, on the transaction device 10; and step S42 of choosing payment service at the homepage. An account number for the service provider can be stored in the transaction device 12 for consumers' convenience. The choosing payment step S42 starts the asking money transaction step S43. Data handled by the asking money transaction step S43 comprises the account number. In this embodiment, the service provider is the merchant 26. This embodiment is useful for bill payment. The bills may include utility bills, phone bills, rent, loan payment, tax, cable TV subscription, Internet subscription, etc. The service providers may include DWP, Edison, AT&T, etc. When a consumer receives a bill mailed to her home, she clicks the icon for the service provider and the transaction device is automatically connected to the homepage of the service provider. The consumer clicks the payment service of the home page.

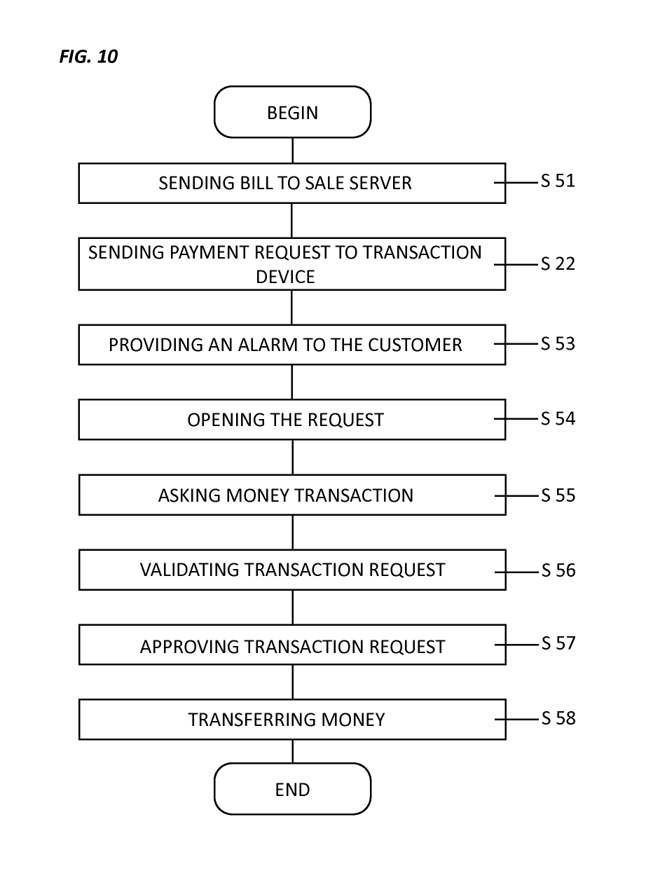

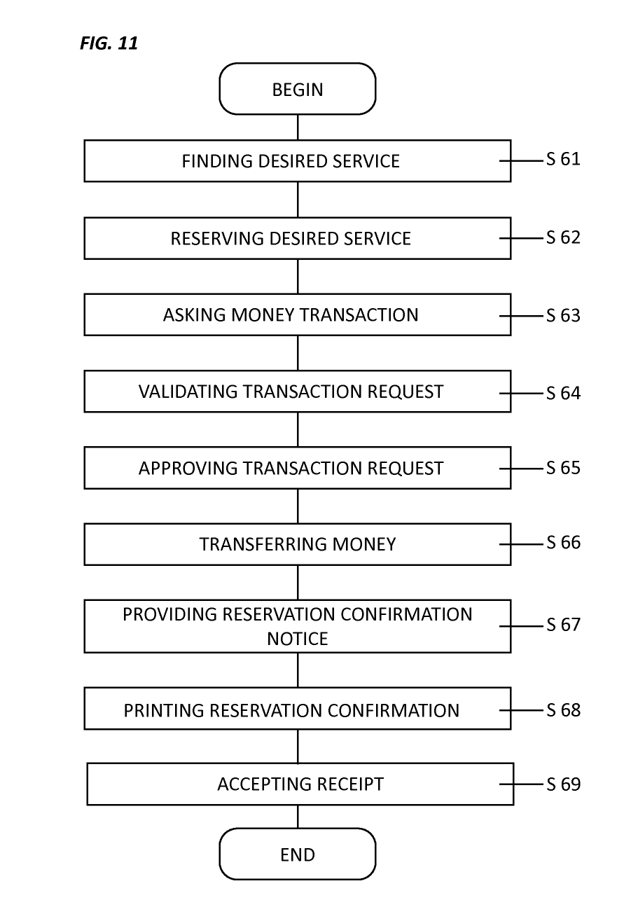

FIG. 10 shows the fifth embodiment of the present invention. In this embodiment, before the step S55 of asking money transaction, the method further comprises step S51 of sending a bill to the sale server 12 by a service provider, step S52 sending a bill payment request by the sale server 12 to the transaction device 10 of a consumer to which an account number of the service provider corresponds, and step S54 of opening the bill payment request by the consumer to review contents of the bill payment request. The bill payment request is stored in an invoice folder 34 (refer to FIG. 1) of the transaction device 10. In this embodiment, the service provider is the merchant 26. The method further comprises, after sending the bill payment request step S52, a step S53 of providing an alarm by the transaction device to the consumer. This embodiment is also useful for bill payment. The service providers send bill to the sale server 12. The sale server 12 sends each bill to the bill payer's transaction device 10. The sale server recognizes the consumer or the bill payer by the account number of the corresponding service. When a new message or bill is delivered to the invoice folder 34, the transaction device automatically generates visual or audible alarm. The consumer clicks the new bill or invoice, checks the description and usage charges then pays the bill.

FIG. 10 shows the sixth embodiment of the present invention. In this embodiment, before the step S63 of asking money transaction, the method further comprises step S61 of finding a desired service by a service provider at the transaction device 10; and step S62 of reserving the desired service with the service provider's website at the transaction device 10. After approving the money transaction request step S63, the method further comprises step S67 of providing a reservation confirmation notice by the transaction device; step S68 of printing reservation confirmation information and number or barcode on a receipt by the transaction device; and step S69 of accepting the receipt by the service provider before providing the service to the consumer. The service provider shares data with the transaction device 10. In this embodiment, the service provider is the merchant 26. This embodiment is useful for reserving tickets for theater, sports event, flight, etc. For example, the consumer checks trailers and show times for a movie using Apps 36 (refer to FIG. 1) of the transaction device 10 for movie trailers. Then the consumer tries reservation via a server of a nearby theater to which the transaction device is registered. When the user inputs the movie name, showing time and number of visitors to the transaction device, it provides notice for reservation confirmation and outputs bar code or reservation confirmation number to a printed receipt. When the consumer produces the receipt at the theater, they check the reservation confirmation and allow entry.

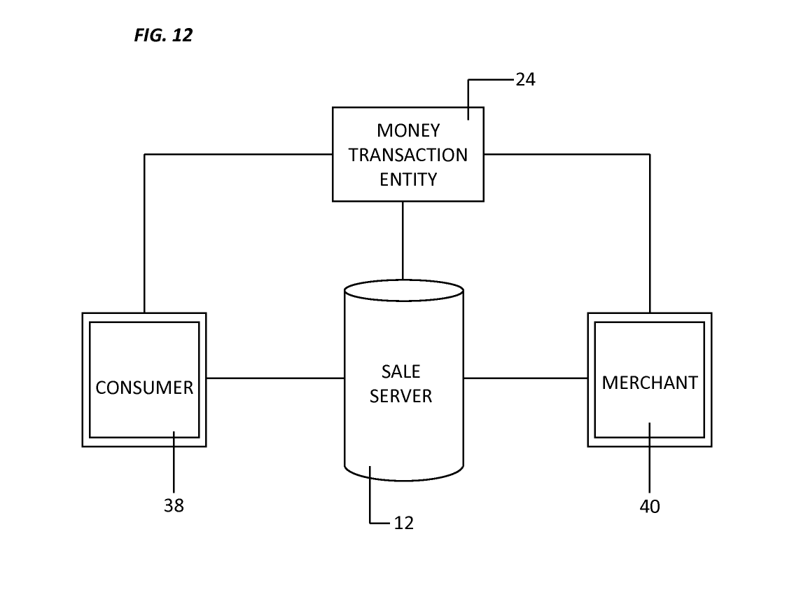

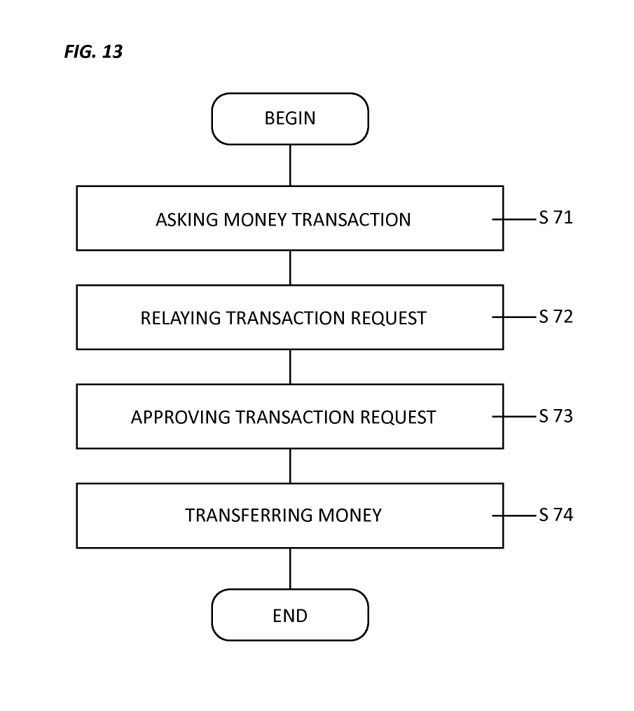

FIGS. 12˜14 show another aspect of the present invention in which both the consumer and the merchant utilize the transaction device of the present invention. FIG. 13 shows the seventh embodiment of the invention in which a home-based money transaction method comprises step S71 of asking money transaction by the consumer by inputting a money transaction request to a first transaction device 38, wherein the first transaction device 38 is located in the consumer's address; step S72 of relaying the money transaction request to a second transaction device 40 by the sale server 12, wherein the second transaction device 40 is located in the merchant's address; step S73 of approving the money transaction request by the money transaction entity; and step S74 of transferring money, the amount of which is specified in the money transaction request to the merchant. The first transaction device 38, the sale server 12, the second transaction device 40 and the money transaction entity 24 are connected with one another via the Internet. The first transaction device 38 provides data for geographic location in which the first transaction device 38 is located and the second transaction device 40 provides data for geographic location in which the second transaction device 40 is located. In the relaying step S72, the sale server 12 authenticates the identity of the first transaction device 38 by comparing the geographic location data of the first transaction device 38 with the address of the consumer, and authenticates the identity of the second transaction device 40 by comparing the geographic location data of the second transaction device 40 with the address of the merchant. In the step of asking transaction S71, the first transaction device 38 displays an order and payment window that is stored in the first transaction device 38 and the consumer places an order and inputs payment data. In the step S72 of relaying, the money transaction request comprises the order data and the payment data. In the step S73 of approving, the money transaction entity communicates with the second transaction device 40. In the step S74 of transferring money, the second transaction device 40 prints a receipt for the money transaction. The second transaction device 40 displays the order data and the payment data in an order and payment window that is stored in the second transaction device 40. This embodiment is especially useful for small delivery businesses. For each business that is connected to the sale server, a template for the order and payment window is stored in the transaction device in advance. Using the transaction device of the present invention by both parties of the transaction, the consumer and the merchant greatly simplifies authentication procedures and increase security. By utilizing services that are possible with the sale server and the transaction device of the present invention, procedural burden by the bank or credit card companies are substantially reduced and small businesses can make far simpler contract with bank or credit card companies.

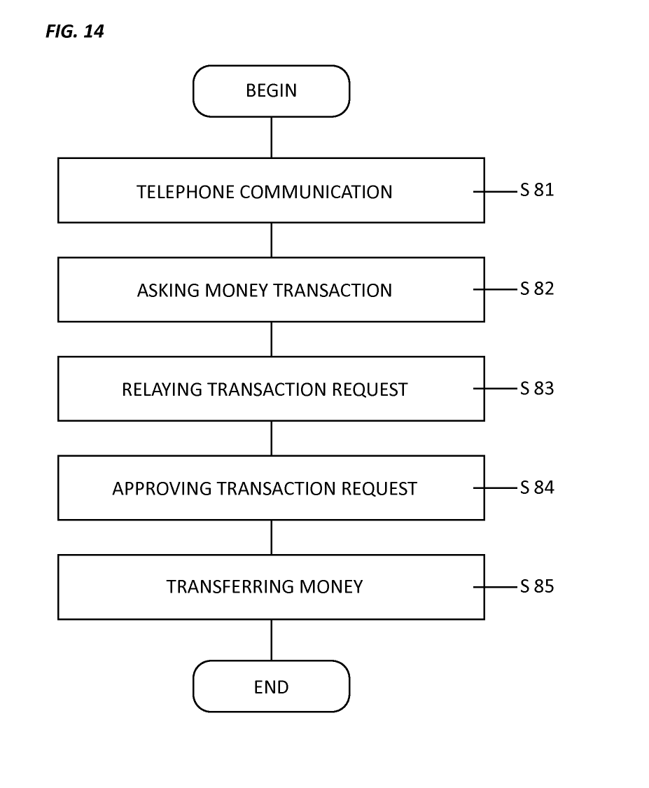

FIG. 14 shows the eighth embodiment. The method in this embodiment, before the step S82 of asking money transaction, further comprises a step S81 of telephone communication in which the consumer calls the merchant. The first transaction device 38 and the second transaction device 40 provide VoIP function and the telephone communication is performed with the first transaction device 38 and the second transaction device 40. The merchant inputs order data to the second transaction device 40 and the sale server 12 transfers the order data to the first transaction device 38 and the first transaction device 38 displays the order data. In the step S85 of transferring money, the first transaction device 38 prints a first receipt for the money transaction and the second transaction device 40 prints a second receipt for the money transaction. VoIP communication between the transaction devices are free and stable. Both the consumer and the merchant have a paper receipt for record when the transaction is complete.

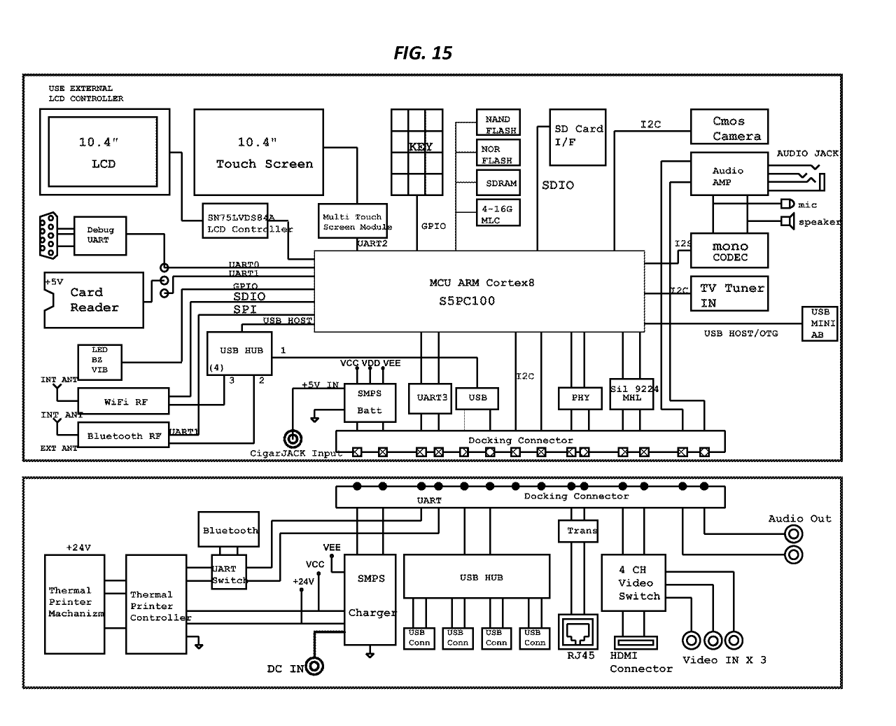

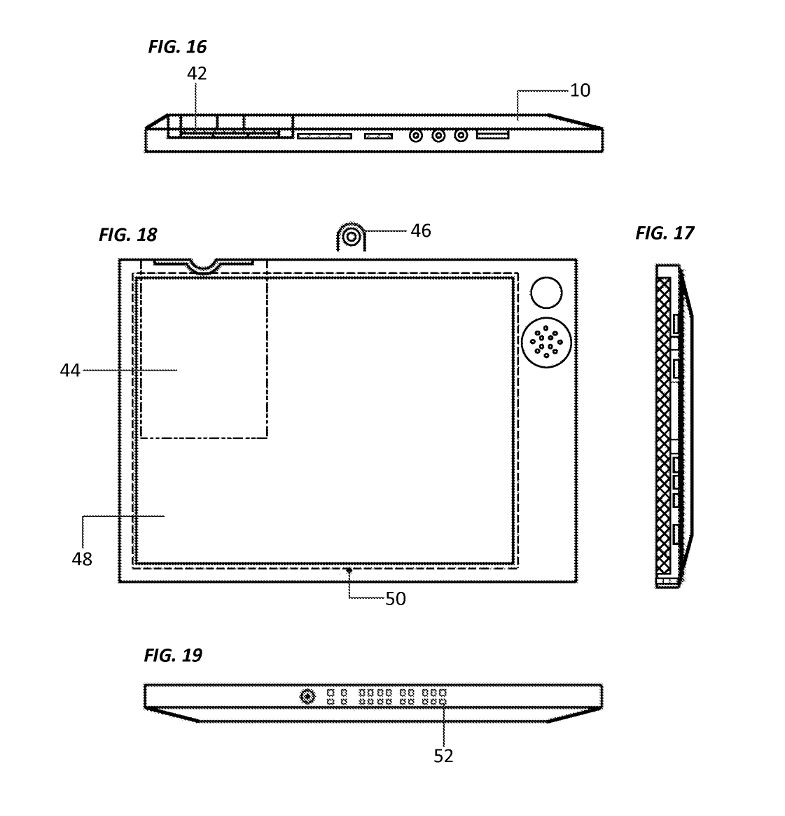

FIGS. 15˜19 show a detailed hardware construction example of the transaction device 10, 38, 40 of the present invention. FIG. 15 shows hardware layout of the transaction device. The layout shows that the transaction device provide various functions that are typical to a small scale computer including LCD display, touch screen, camera, Bluetooth, SD card reader, video/audio/USB connectors and docking connectors. Elements that are peculiar to the transaction device includes card reader, thermal printer and TV tuner. The elements provide functions that are needed in the above-explained embodiments. FIG. 16 shows a slot 42 for inserting a credit card 44 (refer to FIG. 18). FIG. 18 shows a plugin type camera 46, an LCD screen 48 and a microphone 50. FIG. 19 shows docking contacts 52 for connecting to a docking station.

1. A home-based money transaction method comprising steps of:
a) asking money transaction by a consumer by inputting a money transaction request to a transaction device, wherein the transaction device is located in the consumer's address; and
b) validating the money transaction request by a sale server;
wherein the transaction device is connected to the sale server via the Internet, wherein the transaction device provides data for geographic location in which the transaction device is located, wherein in the validating step, the sale server authenticates the identity of the transaction device by comparing the geographic location data of the transaction device with the address of the consumer.

2. The method of claim 1, wherein the transaction device comprises a credit card reading module, wherein the inputting of the money transaction request is performed by reading a credit card and reading amount of money for which money transaction is requested.

3. The method of claim 2, wherein the transaction device comprises a GPS module, wherein the geographic location data comprises a location data of the transaction device provided by the GPS module.

4. The method of claim 2, wherein the transaction device comprises a TCP/IP node, wherein the geographic location data comprises the MAC address of the TCP/IP node.

5. The method of claim 2, wherein the geographic location data comprises an IP address of a TCP/IP node of the Internet, which is nearest to the transaction device.

6. The method of claim 5, wherein the transaction device comprises a unique device ID, wherein the device ID is linked to identity data of the consumer.

7. The method of claim 6, wherein after the step of validating, further comprising steps of:
a) approving the money transaction request by a money transaction entity; and
b) transferring money, the amount of which is specified in the money transaction request to a merchant that is specified in the money transaction request,
wherein the sale server, the money transaction entity and the merchant are connected with one another via the Internet.

8. The method of claim 7, wherein before the step of asking money transaction, further comprising steps of:
a) online shopping in which the consumer chooses goods or service occurs in a online shopping mall website; and
b) sending data for the chosen goods or service by the online shopping mall website to the sale server;
wherein the merchant is an online shopping mall that operates the online shopping mall website, wherein in the asking money transaction step, the sale server provides a web interface for inputting money transaction that shows the amount for the chosen goods or services, wherein the online shopping mall shares data with the sale server.

9. The method of claim 7, wherein before the step of asking money transaction, further comprising steps of:
a) connecting to a TV home shopping mall website with the transaction device, wherein the transaction device provides an icon for the TV home shopping mall website;
b) inputting a product ID to the transaction device, wherein the product ID is known by the TV home shopping channel broadcasting; and
c) obtaining price data and product information for the product ID, wherein the sale server asks the price for the product ID to a TV home shopping mall that operates the TV home shopping mall website and obtains the price data from the TV shopping mall;
wherein the merchant is the TV shopping mall.

10. The method of claim 7, before the step of asking money transaction, further comprising steps of:
a) sending price data to the sale server by the merchant; and
b) displaying the price data for a product provided by the merchant at the transaction device,
wherein in the asking money transaction step, the price data is used as the amount of money for which money transaction is requested, wherein the sale server provides the price data to the transaction device.

11. The method of claim 7, wherein before the step of asking money transaction, further comprising steps of:
a) choosing an icon, which points to the homepage of a service provider for which a bill is to be paid, on the transaction device; and
b) choosing payment service at the homepage;
wherein an account number for the service provider is stored in the transaction device, wherein the choosing payment step starts the asking money transaction step, wherein data handled by the asking money transaction step comprises the account number, and wherein the service provider is the merchant.

12. The method of claim 7, wherein before the step of asking money transaction, further comprising steps of:
a) sending a bill to the sale server by a service provider;
b) sending a bill payment request by the sale server to the transaction device of a consumer to which an account number of the service provider corresponds, wherein the bill payment request is stored in an invoice folder of the transaction device; and
c) opening the bill payment request by the consumer to review contents of the bill payment request;
wherein the service provider is the merchant.

13. The method of claim 12, wherein after sending the bill payment request step, further comprising a step of providing an alarm by the transaction device to the consumer.

14. The method of claim 7, wherein before the step of asking money transaction, further comprising steps of:
a) finding a desired service by a service provider at the transaction device; and
b) reserving the desired service with the service provider's website at the transaction device;
wherein after approving the money transaction request step, further comprising steps of:
c) providing an reservation confirmation notice by the transaction device;
d) printing reservation confirmation information and number or barcode on a receipt by the transaction device; and
e) accepting the receipt by the service provider before providing the service to the consumer;
wherein the service provider shares data with the transaction device, wherein the service provider is the merchant.

15. The method of claim 7, wherein the transaction device comprises a GPS module, wherein the geographic location data comprises a location data of the transaction device provided by the GPS module.

16. The method of claim 7, wherein the transaction device comprises a TCP/IP node, wherein the geographic location data comprises the MAC address of the TCP/IP node.

17. The method of claim 7, after the step of validating and before the step of approving, further comprising a step of authenticating the consumer in which the consumer inputs consumer authentication data into the transaction device.

18. The method of claim 17, wherein the consumer authentication data comprises the zip code of the consumer's billing address and the sale server compares the zip code input with the zip code of the transaction device that is preregistered at the sale server.

19. The method of claim 17, wherein the consumer authentication data further comprises signature of the consumer, wherein in the consumer signs at a touch screen of the transaction device.

20. A home-based money transaction method comprising the steps of:
a) asking money transaction by a consumer by inputting a money transaction request to a first transaction device, wherein the first transaction device is located in the consumer's address;
b) relaying the money transaction request to a second transaction device by a sale server, wherein the second transaction device is located in a merchant's address;
c) approving the money transaction request by a money transaction entity; and
d) transferring money, the amount of which is specified in the money transaction request to the merchant;
wherein the first transaction device, the sale server, the second transaction device and the money transaction entity are connected with one another via the Internet, wherein the first transaction device provides data for geographic location in which the first transaction device is located and the second transaction device provides data for geographic location in which the second transaction device is located; wherein in the relaying step, the sale server authenticates the identity of the first transaction device by comparing the geographic location data of the first transaction device with the address of the consumer, and authenticates the identity of the second transaction device by comparing the geographic location data of the second transaction device with the address of the merchant.

21. The method of claim 20, wherein in the step of asking transaction, the first transaction device displays an order and payment window that is stored in the first transaction device and the consumer places an order and inputs payment data, wherein in the step of relaying, the money transaction request comprises the order data and the payment data, wherein in the step of approving, the money transaction entity communicates with the second transaction device, wherein in the step of transferring money, the second transaction device prints a receipt for the money transaction.

22. The method of claim 21, wherein the second transaction device displays the order data and the payment data in an order and payment window that is stored in the second transaction device.

23. The method of claim 20, before the step of asking money transaction, further comprising a step of telephone communication in which the consumer calls the merchant, wherein the first transaction device and the second transaction device provide VoIP function and the telephone communication is performed with the first transaction device and the second transaction device, wherein the merchant inputs order data to the second transaction device and the sale server transfers the order data to the first transaction device and the first transaction device displays the order data; wherein in the step of transferring money, the first transaction device prints a first receipt for the money transaction and the second transaction device prints a second receipt for the money transaction.
